(19) United States
(12) Patent Application Publication
(10) Pub. No.: US 2023/0258849 A1
(43) Pub. Date: Aug. 17, 2023

(54) LIQUID CRYSTAL OPTICAL ELEMENT

(71) Applicants: Japan Display Inc., Tokyo (JP); OSAKA UNIVERSITY, Osaka (JP)

(72) Inventors: Shinichiro OKA, Tokyo (JP); Yasushi TOMIOKA, Tokyo (JP); Junji KOBASHI, Tokyo (JP); Hiroyuki YOSHIDA, Osaka (JP)

(73) Assignees: Japan Display Inc., Tokyo (JP); OSAKA UNIVERSITY, Osaka (JP)

(21) Appl. No.: 18/304,810

(22) Filed: Apr. 21, 2023

Related U.S. Application Data
(63) Continuation of application No. PCT/JP2021/025455, filed on Jul. 6, 2021.

(30) Foreign Application Priority Data
Oct. 22, 2020 (JP) 2020-177508

(51) Int. Cl. G02B 5/18; G02B 5/30

(52) U.S. Cl. CPC G02B 5/1833; G02B 5/3016; G02B 5/208

(57) ABSTRACT

According to one embodiment, a liquid crystal optical element includes a substrate, a first alignment film, a second alignment film opposite to the first alignment film, a spacer between the substrate and the second alignment film, and a liquid crystal layer in contact with the first alignment film and the second alignment film. The liquid crystal layer includes liquid crystal molecules including a plurality of first liquid crystal molecules arranged along a boundary surface with the first alignment film and a plurality of second liquid crystal molecules arranged along a boundary surface with the second alignment film, and is cured in a state where alignment directions of the liquid crystal molecules are fixed.

### CROSS-REFERENCE TO RELATED APPLICATIONS

This application is a Continuation Application of PCT Application No. PCT/JP2021/025455, filed Jul. 6, 2021 and based upon and claiming the benefit of priority from Japanese Patent Application No. 2020-177508, filed Oct. 22, 2020, the entire contents of all of which are incorporated herein by reference.

### FIELD

Embodiments described herein relate generally to a liquid crystal optical element.

### BACKGROUND

For example, a liquid crystal polarizing grating using a liquid crystal material has been proposed. Such a liquid crystal polarizing grating divides incident light into 0th-order diffracted light and first-order diffracted light when light having a wavelength λ is incident. In an optical element using the liquid crystal material, it is necessary to adjust parameters such as refractive anisotropy or birefringence Δn of a liquid crystal layer (a difference between a refractive index ne of the liquid crystal layer for extraordinary light and a refractive index no of the liquid crystal layer for ordinary light) and a thickness d of the liquid crystal layer in addition to a grating period.

### BRIEF DESCRIPTION OF THE DRAWINGS

FIG. 1 is a cross-sectional view schematically showing a liquid crystal optical element 1.

FIG. 2 is a diagram for describing an example of a method for manufacturing the liquid crystal optical element 1 shown in FIG. 1.

FIG. 3 is a plan view schematically showing an example of an alignment pattern in a liquid crystal layer LC.

FIG. 4 is a plan view schematically showing another example of the alignment pattern in the liquid crystal layer LC.

FIG. 5 is a cross-sectional view schematically showing a first configuration example of the liquid crystal optical element 1.

FIG. 6 is a cross-sectional view schematically showing a second configuration example of the liquid crystal optical element 1.

FIG. 7 is a cross-sectional view schematically showing a third configuration example of the liquid crystal optical element 1.

FIG. 8 is a cross-sectional view schematically showing a fourth configuration example of the liquid crystal optical element 1.

### DETAILED DESCRIPTION

An object of an embodiment is to provide a liquid crystal optical element capable of obtaining desired optical performance.

In general, according to one embodiment, a liquid crystal optical element comprises: a substrate including a first main surface; a first alignment film disposed on the first main surface; a second alignment film opposite to the first alignment film; a spacer disposed between the substrate and the second alignment film; and a liquid crystal layer in contact with the first alignment film and the second alignment film, wherein the liquid crystal layer includes liquid crystal molecules including a plurality of first liquid crystal molecules arranged along a boundary surface with the first alignment film and a plurality of second liquid crystal molecules arranged along a boundary surface with the second alignment film, and is cured in a state where alignment directions of the liquid crystal molecules are fixed.

According to one embodiment, a liquid crystal optical element capable of obtaining desired optical performance can be provided.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X-axis, a Y-axis and a Z-axis orthogonal to each other. A direction along the Z-axis is referred to as a Z-direction or a first direction, a direction along the Y-axis is referred to as a Y-direction or a second direction and a direction along the X-axis is referred to as an X-direction or a third direction. A plane defined by the X-axis and the Y-axis is referred to as an X-Y plane.

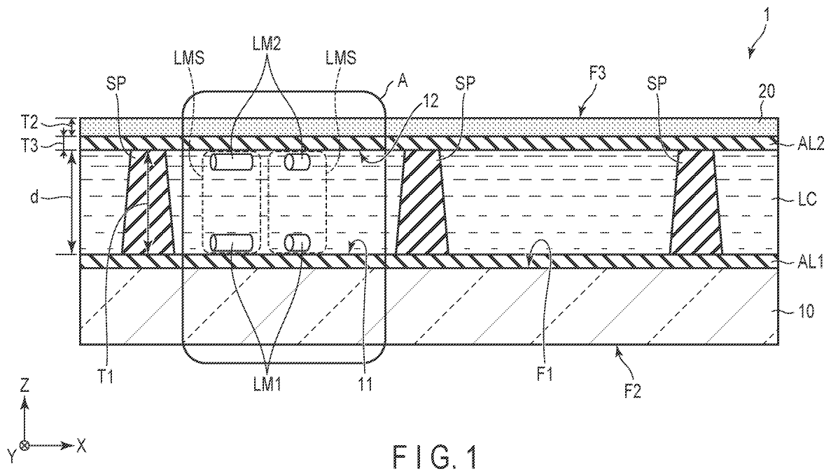

FIG. 1 is a cross-sectional view schematically showing a liquid crystal optical element 1 according to the present embodiment. The liquid crystal optical element 1 includes a substrate 10, a first alignment film AL1, a second alignment film AL2, spacers SP, a liquid crystal layer LC, and a thin film 20.

The substrate 10 is a transparent substrate that transmits light, and is made of, for example, a transparent glass plate or a transparent synthetic resin plate. The substrate 10 may be made of, for example, a transparent synthetic resin plate having flexibility. The substrate 10 can be formed in any shape. For example, the substrate may be curved. For example, a refractive index of the substrate 10 is larger than a refractive index of air.

In the present specification, “light” includes visible light and invisible light. For example, a lower limit wavelength of a visible light range is 360 nm or more and 400 nm or less, and an upper limit wavelength of the visible light range is 760 nm or more and 830 nm or less. The visible light includes a first component (blue component) in a first wavelength range (for example, from 400 nm to 500 nm), a second component (green component) in a second wavelength range (for example, from 500 nm to 600 nm), and a third component (red component) in a third wavelength range (for example, from 600 nm to 700 nm). The invisible light includes an ultraviolet ray in a wavelength range shorter than the first wavelength range and an infrared ray in a wavelength range longer than the third wavelength range.

In the present specification, “transparent” is preferably colorless and transparent. However, “transparent” may be translucent or colored transparent.

The substrate 10 is formed in a flat plate shape along an X-Y plane, and includes a first main surface F1 and a second main surface F2. The first main surface F1 and the second main surface F2 are planes approximately parallel to the X-Y plane, and are opposed to each other in a Z-direction. The second main surface F2 is, for example, in contact with air, but may be covered with another thin film.

The first alignment film AL1 is disposed on the first main surface F1 of the substrate 10. In the example illustrated in FIG. 1, the first alignment film AL1 is in contact with the substrate 10. Incidentally, another thin film may be interposed between the first alignment film AL1 and the substrate 10. The first alignment film AL1 is formed of, for example, polyimide.

The second alignment film AL2 is opposed to the first alignment film AL1 in the Z-direction. The second alignment film AL2 may be formed of the same material as the first alignment film AL1, or may be formed of a material different from the first alignment film AL1. The first alignment film AL1 and the second alignment film AL2 are both horizontal alignment films having an alignment restriction force along the X-Y plane.

Here, anchoring strength will be discussed. The anchoring strength in the present specification indicates a magnitude of the alignment restriction force, and corresponds to so-called azimuth angle anchoring strength. Such anchoring strength represents a magnitude of interaction between the alignment films and liquid crystal molecules, and is simply referred to as “anchoring strength of the alignment film”.

The anchoring strength of the second alignment film AL2 is desirably smaller than the anchoring strength of the first alignment film AL1. For example, the anchoring strength of the first alignment film AL1 is 1*10⁻⁴ J/m² or more, and the anchoring strength of the second alignment film AL2 is 1*10⁻⁶ J/m² or less. Incidentally, the anchoring strength of each of the first alignment film AL1 and the second alignment film AL2 may be 1*10⁻⁴ J/m² or more.

The spacers SP are disposed between the substrate 10 and the second alignment film AL2 in the Z-direction. The spacers SP may be columnar spacer extending in the Z-direction or substantially spherical beads. The spacers SP are desirably transparent.

For example, the spacers SP are formed in a columnar shape in a step after the first alignment film AL1 is formed. In this case, as shown in FIG. 1, the spacers SP overlap the first alignment film AL1 in the Z-direction, and are disposed between the first alignment film AL1 and the second alignment film AL2. In addition, the spacers SP are in contact with the first alignment film AL1 and the second alignment film AL2.

Incidentally, the spacers SP may be formed in a step before the first alignment film AL1 is formed. In this case, the spacers SP are formed to be in contact with the first main surface F1, and are disposed between the substrate 10 and the second alignment film AL2 in the Z-direction. At this time, the first alignment film AL1 is formed to cover at least a part of the spacers SP. The spacers SP may be in contact with the second alignment film AL2, or the first alignment film AL1 may be interposed between the spacers SP and the second alignment film AL2.

The liquid crystal layer LC is disposed between the first alignment film AL1 and the second alignment film AL2, and is in contact with the first alignment film AL1 and the second alignment film AL2. In the example illustrated in FIG. 1, a thickness d of the liquid crystal layer LC along the Z-direction is equal to a thickness T1 of the spacer SP. The liquid crystal layer LC is not interposed between the spacers SP and the second alignment film AL2.

The liquid crystal layer LC includes a plurality of liquid crystal structures LMS having different alignment directions. As a result, the plurality of liquid crystal structures LMS can take a linear alignment pattern or a non-linear alignment pattern. The linear alignment pattern indicates a pattern in which the alignment directions of the plurality of liquid crystal structures LMS change linearly. The term “change linearly” means that, for example, the amount of changes in the alignment directions of the liquid crystal structures LMS is represented by a first-order function. The non-linear alignment pattern indicates a pattern in which the alignment directions of the plurality of liquid crystal structures LMS change non-linearly. The term “change non-linearly” indicates that, for example, the amount of changes in the alignment directions of the liquid crystal structures LMS is represented by an Nth-order function. “N” represents an integer of 2 or more.

The liquid crystal structure LMS includes first liquid crystal molecules LM1 located on one end side thereof and second liquid crystal molecules LM2 located on the other end side thereof. The first liquid crystal molecules LM1 are near to the first alignment film AL1, and the second liquid crystal molecules LM2 are near to the second alignment film AL2. The plurality of liquid crystal molecules including the first liquid crystal molecules LM1 and the second liquid crystal molecules LM2 in each liquid crystal structure LMS are arranged in the Z-direction, and each of the liquid crystal molecules is aligned in a predetermined direction on the X-Y plane.

In the liquid crystal layer LC, alignment directions of the plurality of first liquid crystal molecules LM1 arranged along a boundary surface 11 with the first alignment film AL1 and alignment directions of the plurality of second liquid crystal molecules LM2 arranged along a boundary surface 12 with the second alignment film AL2 change linearly or non-linearly.

Alternatively, the amount of changes in the alignment directions of the first liquid crystal molecules LM1 and the amount of changes in the alignment directions of the second liquid crystal molecules LM2 are represented by an Nth-order function when N is an integer of 1 or more. As described above, a case where N is 1 corresponds to a case where the alignment directions change linearly, and a case where N is 2 or more corresponds to a case where the alignment directions change non-linearly.

Here, the alignment directions of the liquid crystal molecules can be expressed as, for example, an angle θL formed by a major axis of the liquid crystal molecules aligned on the X-Y plane and the X-axis. The amount of changes in the alignment directions of the first liquid crystal molecules LM1 can be expressed as a difference in the alignment directions of the first liquid crystal molecules LM1 of each of two liquid crystal structures LMS arranged at a pitch corresponding to a unit length L, in other words, a difference in angle per unit length (ΔθL/L). Similarly, the amount of changes in the alignment directions of the second liquid crystal molecules LM2 can be expressed as a difference in the alignment directions of the second liquid crystal molecules LM2 of each of two liquid crystal structures LMS arranged at a pitch corresponding to the unit length L.

The liquid crystal layer LC of the present embodiment is cured in a state where the alignment directions of the liquid crystal molecules including the first liquid crystal molecules LM1 and the second liquid crystal molecules LM2 are fixed. In other words, the alignment directions of the liquid crystal molecules are not controlled in accordance with an electric field. For this reason, the liquid crystal optical element 1 does not include an electrode for alignment control. Such a liquid crystal layer LC is formed, for example, by polymerizing a monomer by applied energy such as light.

The thin film 20 overlaps the second alignment film AL2 in the Z-direction. In other words, the second alignment film AL2 is located between the liquid crystal layer LC and the thin film 20 and between the spacers SP and the thin film 20. The thin film 20 is transparent, and is, for example, a polyimide-based organic film, but may be an inorganic film. A film thickness T2 of the thin film 20 along the Z-direction is larger than a film thickness T3 of the second alignment film AL2. Other thin films or substrates do not overlap the thin film 20 in the Z-direction. In other words, the thin film 20 includes a main surface F3 in contact with air.

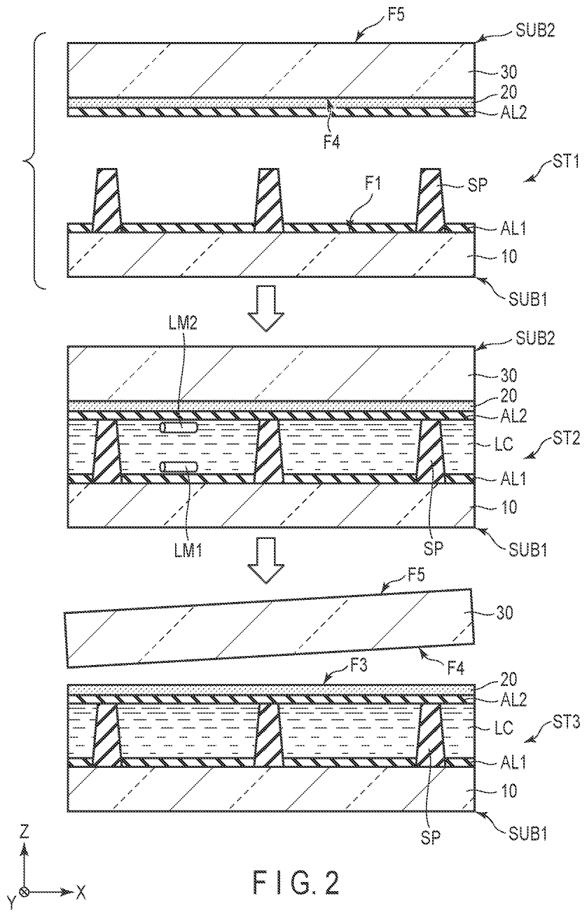

FIG. 2 is a diagram for describing an example of a method for manufacturing the liquid crystal optical element 1 shown in FIG. 1.

First, in step ST1, a first substrate SUB1 and a second substrate SUB2 are prepared.

The first substrate SUB1 is formed as follows, for example. Here, a case where the spacers SP are formed before the first alignment film AL1 will be described. First, the columnar spacers SP are formed on the first main surface F1 of the substrate 10 by using a transparent organic material. Thereafter, an alignment film material is applied to the first main surface F1, and the first alignment film AL1 is formed by performing an alignment treatment on a surface of the alignment film material. The alignment treatment is, for example, a photo-alignment treatment, but may be other methods. The alignment restriction force of the first alignment film AL1 is adjusted to have predetermined anchoring strength described above by the alignment treatment.

The second substrate SUB2 is formed as follows, for example. First, a support substrate 30 having main surfaces F4 and F5 opposed to each other is prepared. The support substrate 30 is, for example, a glass substrate. Thereafter, the polyimide-based thin film 20 is formed on the main surface F4 of the support substrate 30. Thereafter, the alignment film material is applied on the thin film 20 to form the second alignment film AL2. Such a second alignment film AL2 has an alignment restriction force exhibiting at least a horizontal alignment property, but the anchoring strength of the second alignment film AL2 is weak as described above.

Subsequently, in step ST2, the first substrate SUB1 and the second substrate SUB2 are bonded to each other, and the liquid crystal layer LC is formed. The liquid crystal layer LC is formed as follows, for example. First, a liquid crystal material is applied to be in contact with the first alignment film AL1. Thereafter, the second substrate SUB2 is overlapped such that the second alignment film AL2 is in contact with the liquid crystal material. The second substrate SUB2 is supported by the spacers SP. The liquid crystal material is cured by irradiation with light such as an ultraviolet ray to form the liquid crystal layer LC.

However, at a stage before the liquid crystal material is cured, the alignment directions of the liquid crystal molecules contained in the liquid crystal material are fixed as follows. That is, each of the first liquid crystal molecules LM1 near to the first alignment film AL1 is horizontally aligned along the X-Y plane by the alignment restriction force of the first alignment film AL1, and is aligned in a predetermined direction on the X-Y plane. The alignment directions of the liquid crystal molecules overlapping the first liquid crystal molecules LM1 in the Z-direction are determined in accordance with the alignment directions of the first liquid crystal molecules LM1.

The second liquid crystal molecules LM2 near to the second alignment film AL2 are horizontally aligned along the X-Y plane by the alignment restriction force of the second alignment film AL2. However, since the anchoring strength of the second alignment film AL2 is weak, a degree of freedom is high with respect to the alignment directions of the second liquid crystal molecules LM2 on the X-Y plane. For this reason, the second liquid crystal molecules LM2 are aligned to follow the alignment directions of the first liquid crystal molecules LM1.

Consequently, the alignment directions of the liquid crystal molecules contained in the liquid crystal material are fixed. After the alignment directions of the liquid crystal molecules are fixed in this manner, a curing treatment of the liquid crystal material is performed.

Subsequently, in step ST3, the support substrate 30 is peeled off. For example, Laser Lift Off can be applied as a method for peeling off the support substrate 30. That is, the support substrate 30 is peeled off from the thin film 20 by irradiating the main surface F5 of the support substrate 30 with a high-output laser beam (for example, a laser beam having an ultraviolet wavelength) to heat and decompose an interface between the thin film 20 and the support substrate 30. In other words, the thin film 20 in the present embodiment functions as a peeling agent that absorbs light of a predetermined wavelength and promotes peeling of the support substrate 30 (alternatively, a degree of close contact with the support substrate 30 is reduced). Incidentally, as the support substrate 30 is peeled off, a part or the whole of the thin film 20 may be removed. A surface of the thin film 20 remaining after the support substrate 30 is peeled off forms the main surface F3 in contact with air. In a case where the entire thin film 20 is removed, the second alignment film AL2 is exposed and is in contact with air.

According to the present embodiment, in a procedure of forming the liquid crystal layer LC, the alignment directions of the liquid crystal molecules contained in the applied liquid crystal material are primarily determined by the alignment restriction force of the first alignment film AL1 provided on the first substrate SUB1. In addition, the alignment restriction force of the second alignment film AL2 provided on the second substrate SUB2 suppresses the rise (a state near to a vertical alignment) of the second liquid crystal molecules LM2 near to the second alignment film AL2. Consequently, desired refractive anisotropy Δn can be obtained in the cured liquid crystal layer LC.

In addition, since the spacers SP are provided in the liquid crystal layer LC, deflection of the first substrate SUB1 and the second substrate SUB2 bonded together in the procedure of forming the liquid crystal layer LC is suppressed. Consequently, a gap between the first substrate SUB1 and the second substrate SUB2 along the Z-direction is set to be uniform. Accordingly, the thickness d of the cured liquid crystal layer LC can be set to be uniform.

Accordingly, the liquid crystal layer LC is configured to have a predetermined retardation Δn·d, and the liquid crystal optical element 1 having a desired optical property can be realized.

In a case where the liquid crystal optical element 1 is realized, it is required to form the liquid crystal structures LMS having different alignment directions for each minute region of a wavelength order in the liquid crystal layer LC. For this reason, the alignment treatment is performed on the first alignment film AL1 in different directions for each minute region. In a case where both the first alignment film AL1 and the second alignment film AL2 have high anchoring strength, it is also necessary to perform the same alignment treatment as the first alignment film AL1 on the second alignment film AL2. When the first alignment film AL1 and the second alignment film AL2 are overlapped, extremely high alignment accuracy is required.

In the present embodiment, the anchoring strength of the second alignment film AL2 is weak. In other words, the second alignment film AL2 does not have the anchoring strength high enough to determine the alignment directions of the second liquid crystal molecules LM2. For this reason, the second liquid crystal molecules LM2 are aligned to follow the alignment directions of the first liquid crystal molecules LM1. Accordingly, as compared with a case where both the first alignment film AL1 and the second alignment film AL2 have high anchoring strength, an allowable range for misalignment of the first alignment film AL1 and the second alignment film AL2 on the X-Y plane can be enlarged.

Further, since the support substrate 30 required in the procedure of forming the liquid crystal layer LC is removed, a slimness liquid crystal optical element 1 can be provided.

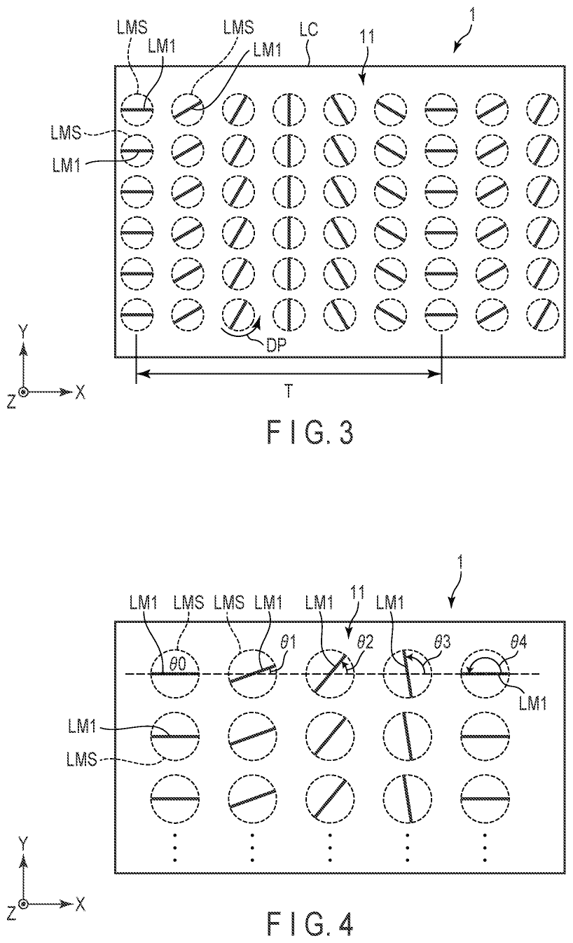

Next, specific examples of the alignment patterns of the plurality of liquid crystal structures LMS included in the liquid crystal layer LC will be described with reference to FIGS. 3 and 4.

FIG. 3 is a plan view schematically showing an example of an alignment pattern in a liquid crystal layer LC. The example illustrated in FIG. 3 corresponds to an example of the linear alignment pattern. FIG. 3 shows an example of spatial phases of the liquid crystal structures LMS. The spatial phases shown here are indicated as the alignment directions of the first liquid crystal molecules LM1 located at the boundary surface 11 with the first alignment film AL1 among the liquid crystal molecules included in the liquid crystal structure LMS. The plurality of liquid crystal structures LMS are arranged along the X-direction and the Y-direction.

For each of the liquid crystal structures LMS arranged along the X-direction, the alignment directions of the first liquid crystal molecules LM1 located at the boundary surface 11 are different from each other. In other words, the spatial phases of the liquid crystal structures LMS at the boundary surface 11 are different along the X-direction.

In contrast, for each of the liquid crystal structures LMS arranged along the Y-direction, the alignment directions of the first liquid crystal molecules LM1 located at the boundary surface 11 are approximately coincident with each other. In other words, the spatial phases of the liquid crystal structure LMS at the boundary surface 11 are approximately coincident with each other in the Y-direction.

In particular, note the liquid crystal structures LMS arranged along the X-direction, the alignment direction of each of the first liquid crystal molecules LM1 changes by a certain angle. In other words, at the boundary surface 11, the alignment directions of the plurality of first liquid crystal molecules LM1 arranged along the X-direction change linearly. Accordingly, the spatial phases of the plurality of liquid crystal structures LMS arranged along the X-direction change linearly.

Here, as shown in FIG. 3, at the boundary surface 11, an interval between two liquid crystal structures LMS when the alignment directions of the first liquid crystal molecules LM1 change by 180 degrees along the X-direction is defined as a period T of the liquid crystal structure LMS. Incidentally, in FIG. 3, DP represents turning directions of the first liquid crystal molecules LM1.

FIG. 4 is a plan view schematically showing another example of the alignment pattern in the liquid crystal layer LC. The example illustrated in FIG. 4 corresponds to an example of the non-linear alignment pattern. The plurality of liquid crystal structures LMS are arranged along the X-direction and the Y-direction. For each of the liquid crystal structures LMS arranged along the X-direction, the alignment directions of the first liquid crystal molecules LM1 located at the boundary surface 11 are different from each other. In contrast, for each of the liquid crystal structures LMS arranged along the Y-direction, the alignment directions of the first liquid crystal molecules LM1 located at the boundary surface 11 are approximately coincident with each other.

In particular, note the liquid crystal structures LMS arranged along the X-direction, the alignment directions of the plurality of liquid crystal structures LMS change non-linearly along the X-direction. Specifically, the amount of changes in the alignment directions of the first liquid crystal molecules LM1 is represented by a second-order function. For example, the alignment directions of the first liquid crystal molecules LM1 change along the X-direction (from left to right in the drawing) as follows: angle θ0→>angle θ1→>angle θ2→>angle θ3→>angle θ4 (θ0<θ1<θ2<θ3<θ4). Each of the angles here is an angle with the X-axis as a criterion. At this time, the amount of changes in the alignment directions of the first liquid crystal molecules LM1 is (θ1−θ0), (θ2−θ1), (θ3−θ2), and (θ4−θ3) along the X-direction, and gradually increases. As described above, at the boundary surface 11, the alignment directions of the plurality of first liquid crystal molecules LM1 arranged along the X-direction change non-linearly. Accordingly, the spatial phases of the plurality of liquid crystal structures LMS arranged along the X-direction change non-linearly.

Next, a specific configuration example of the liquid crystal optical element 1 according to the present embodiment will be described.

### First Configuration Example

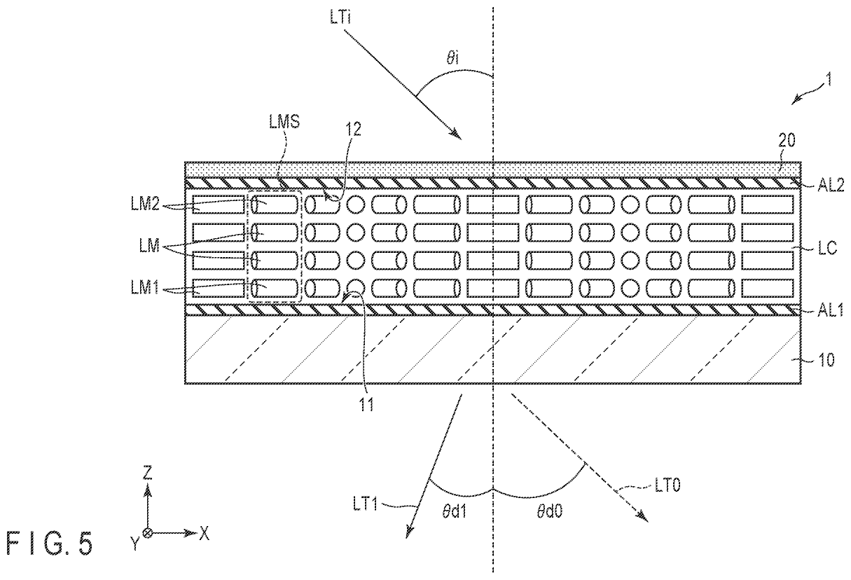

FIG. 5 is a cross-sectional view schematically showing a first configuration example of the liquid crystal optical element 1. The first configuration example corresponds to an example in which the liquid crystal optical element 1 functions as a transmissive type diffraction grating. The liquid crystal layer LC includes a nematic liquid crystal. Incidentally, FIG. 5 corresponds to a cross section of a region A of the liquid crystal optical element 1 shown in FIG. 1.

In the example illustrated in FIG. 5, the liquid crystal layer LC includes a nematic liquid crystal in which alignment directions are approximately coincident with each other. However, a chiral agent may be added to the nematic liquid crystal. In this case, the liquid crystal layer LC includes a twist-aligned nematic liquid crystal.

Note one liquid crystal structure LMS, the alignment direction of the first liquid crystal molecule LM1 and the alignment direction of the second liquid crystal molecule LM2 are approximately coincident with each other. In addition, the alignment directions of another liquid crystal molecules LM between the first liquid crystal molecule LM1 and the second liquid crystal molecule LM2 are also approximately coincident with the alignment directions of the first liquid crystal molecule LM1.

As described with reference to FIG. 3 or 4, the alignment directions of the plurality of first liquid crystal molecules LM1 arranged along the boundary surface 11 with the first alignment film AL1 linearly or non-linearly change along the X-direction. Similarly to the first liquid crystal molecules LM1, the alignment directions of the plurality of second liquid crystal molecules LM2 arranged along the boundary surface 12 with the second alignment film AL2 also change along the X-direction.

Light may be incident on the liquid crystal optical element 1 from the thin film 20 side, or light may be incident on the liquid crystal optical element 1 from the substrate 10 side. Here, a case where light is incident from the thin film 20 side will be described. An incident light LTi is divided into 0th-order diffracted light LT0 and first-order diffracted light LT1 after transmitting through the liquid crystal optical element 1. A diffraction angle θd0 of the 0th-order diffracted light LT0 is equivalent to an incidence angle θi of the incident light LTi. A diffraction angle θd1 of the first-order diffracted light LT1 is different from the incidence angle θi.

### Second Configuration Example

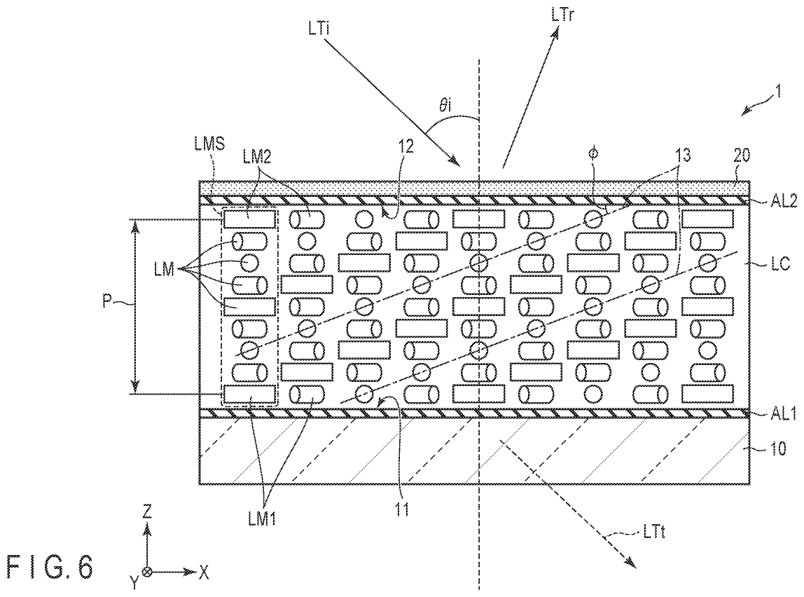

FIG. 6 is a cross-sectional view schematically showing a second configuration example of the liquid crystal optical element 1. The second configuration example corresponds to an example in which the liquid crystal optical element 1 functions as a reflective type diffraction grating. The liquid crystal layer LC includes a cholesteric liquid crystal. Incidentally, in FIG. 6, for the sake of simplification in the drawing, one liquid crystal molecule LM represents a liquid crystal molecule having an average alignment direction among the plurality of liquid crystal molecules located on the X-Y plane. Incidentally, FIG. 6 corresponds to the cross section of the region A of the liquid crystal optical element 1 shown in FIG. 1.

Note one liquid crystal structure LMS, the plurality of liquid crystal molecules LM are spirally stacked along the Z-direction while turning. The alignment direction of the first liquid crystal molecule LM1 and the alignment direction of the second liquid crystal molecule LM2 are approximately coincident with each other. The liquid crystal structure LMS includes a spiral pitch P. The spiral pitch P indicates one period (360 degrees) of a spiral. In the example illustrated in FIG. 6, the spiral pitch P is shown as distance between the first liquid crystal molecule LM1 and the second liquid crystal molecule LM2 along the Z-direction. The thickness d of the liquid crystal layer LC is desirably, for example, quintuple or more of the spiral pitch P.

The alignment directions of the plurality of first liquid crystal molecules LM1 and the plurality of second liquid crystal molecules LM2 change linearly or non-linearly along the X-direction as described with reference to FIG. 3 or 4.

The liquid crystal layer LC includes a plurality of reflective surfaces 13 as indicated by a one-dot chain line between the boundary surface 11 and the boundary surface 12. For example, the plurality of reflective surfaces 13 are approximately parallel to one another. The reflective surfaces 13 are inclined with respect to the boundary surfaces 11 and 12 and each have an approximately planar shape extending in a certain direction. The reflective surface 13 selectively reflects light LTr as a part of incident light LTi and transmits another light LTt according to Bragg's law. The reflective surface 13 reflects the light LTr corresponding to an inclination angle φ of the reflective surface 13 with respect to the boundary surface 12.

The reflective surface 13 here corresponds to a surface in which the alignment directions of the liquid crystal molecules LM are approximately coincident with each other or a surface in which the spatial phases are approximately coincident with each other (equiphase surface). Incidentally, a shape of the reflective surface 13 is not limited to the planar shape, and may be a concave or convex curved surface shape, and is not particularly limited. In addition, a part of the reflective surface 13 may have unevenness, the inclination angle φ of the reflective surface 13 may not be uniform, or the plurality of reflective surfaces 13 may not be regularly aligned. The reflective surface 13 having any shape can be formed in accordance with a spatial phase distribution of the liquid crystal structures LMS.

The cholesteric liquid crystal which is the liquid crystal structure LMS reflects circularly polarized light in the same turning direction as the turning direction of the cholesteric liquid crystal, of light having a predetermined wavelength λ, included in a selective reflection range Δλ. For example, in a case where the turning direction of the cholesteric liquid crystal is clockwise, of the light having the predetermined wavelength λ, clockwise circularly polarized light is reflected, and counterclockwise circularly polarized light is transmitted. Similarly, in a case where the turning direction of the cholesteric liquid crystal is counterclockwise, of the light having the predetermined wavelength λ, counterclockwise circularly polarized light is reflected, and clockwise circularly polarized light is transmitted.

When a spiral pitch of the cholesteric liquid crystal is denoted by P, a refractive index of the liquid crystal molecule for extraordinary light is denoted by ne, and a refractive index of the liquid crystal molecules for ordinary light is denoted by no, in general, the selective reflection range Δλ of the cholesteric liquid crystal for perpendicularly incident light is represented by “from no*P to ne*P”. Incidentally, specifically, the selective reflection range Δλ of the cholesteric liquid crystal changes in accordance with the inclination angle φ of the reflective surface 13, the incidence angle θi, and the like with respect to a range “from no*P to ne*P”.

### Third Configuration Example

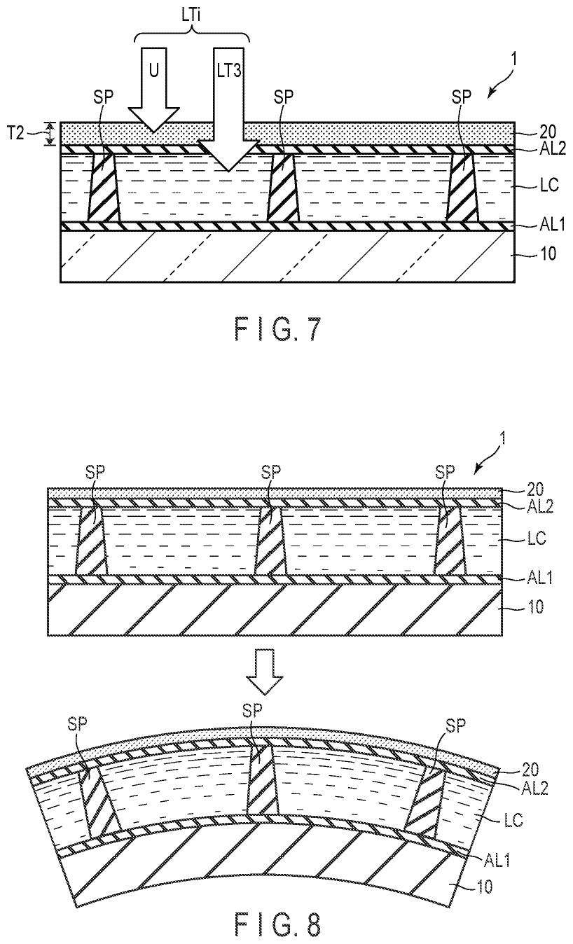

FIG. 7 is a cross-sectional view schematically showing a third configuration example of the liquid crystal optical element 1. In the third configuration example, the thin film 20 overlapping the second alignment film AL2 is an ultraviolet cut layer. The thin film 20 is, for example, a polyimide-based organic film, and is thicker than the second alignment film AL2. The film thickness T2 of the thin film 20 is, for example, 10 μm or more.

In a case where the light LTi including an ultraviolet ray U is incident on the liquid crystal optical element 1, the ultraviolet ray U does not transmit through the thin film 20. Light LT3 having another wavelength is transmitted through the thin film 20 and reaches the liquid crystal layer LC. The thin film 20 as the ultraviolet cut layer may absorb the incident ultraviolet ray or may reflect the incident ultraviolet ray. However, from a point of view of promoting the peeling of the support substrate in the Laser Lift Off described with reference to FIG. 2, the thin film 20 desirably absorbs a laser beam having an ultraviolet wavelength applied in the Laser Lift Off.

According to such a third configuration example, the arrival of the ultraviolet ray U to the liquid crystal layer LC is suppressed. Consequently, it is possible to suppress degradation or coloring of the liquid crystal layer LC due to the ultraviolet ray U.

Such a third configuration example can be combined with the first configuration example or the second configuration example described above.

### Fourth Configuration Example

FIG. 8 is a cross-sectional view schematically showing a fourth configuration example of the liquid crystal optical element 1. In the fourth configuration example, the substrate 10 is a flexible substrate, and is formed by using, for example, polyimide, polyaramide, or the like.

According to such a fourth configuration example, the liquid crystal optical element 1 having any shape can be provided, and for example, the liquid crystal optical element 1 having a curved shape as shown in the drawing can be provided.

Such a fourth configuration example can be combined with any of the first configuration example, the second configuration example, and the third configuration example described above.

In the first configuration example, the second configuration example, the third configuration example, and the fourth configuration example, the liquid crystal layer LC is cured in a state where the alignment directions of the plurality of liquid crystal molecules are fixed as described above.

In such a liquid crystal layer LC, the alignment directions of the plurality of first liquid crystal molecules LM1 near to the first alignment film AL1 and the alignment directions of the plurality of second liquid crystal molecules LM2 near to the second alignment film AL2 change linearly or non-linearly.

Alternatively, in liquid crystal layer LC, the amount of changes in the alignment directions of the first liquid crystal molecules LM1 and the amount of changes in the alignment directions of the second liquid crystal molecules LM2 are represented by an Nth-order function when N is an integer of 1 or more. A case where N is 1 corresponds to a case where the alignment directions change linearly, and a case where N is 2 or more corresponds to a case where the alignment directions change non-linearly.

The anchoring strength of the second alignment film AL2 is desirably smaller than the anchoring strength of the first alignment film AL1. For example, the anchoring strength of the first alignment film AL1 is 1*10⁻⁴ J/m² or more, and the anchoring strength of the second alignment film AL2 is 1*10⁻⁶ J/m² or less.

Further, the thin film 20 overlaps the second alignment film AL2, and the film thickness of the thin film 20 is larger than the film thickness of the second alignment film AL2.

As described above, according to the present embodiment, it is possible to provide the liquid crystal optical element capable of obtaining the desired optical performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a substrate including a first main surface;
a first alignment film disposed on the first main surface;
a second alignment film opposite to the first alignment film;
a spacer disposed between the substrate and the second alignment film; and
a liquid crystal layer in contact with the first alignment film and the second alignment film,
wherein the liquid crystal layer includes liquid crystal molecules including a plurality of first liquid crystal molecules arranged along a boundary surface with the first alignment film and a plurality of second liquid crystal molecules arranged along a boundary surface with the second alignment film, and is cured in a state where alignment directions of the liquid crystal molecules are fixed.

2. The liquid crystal optical element according to claim 1, wherein the alignment directions of the first liquid crystal molecules and the alignment directions of the second liquid crystal molecules change linearly or non-linearly.

3. The liquid crystal optical element according to claim 2, wherein the amount of changes in the alignment directions of the first liquid crystal molecules and the amount of changes in the alignment directions of the second liquid crystal molecules are represented as a Nth-order function when N is an integer of 1 or more.

4. The liquid crystal optical element according to claim 1, wherein anchoring strength of the second alignment film is smaller than anchoring strength of the first alignment film.

5. The liquid crystal optical element according to claim 4, wherein the anchoring strength of the second alignment film is 1*10⁻⁶ J/m² or less.

6. The liquid crystal optical element according to claim 1, further comprising:
a thin film overlapping the second alignment film,
wherein a film thickness of the thin film is larger than a film thickness of the second alignment film.

7. The liquid crystal optical element according to claim 1, wherein the liquid crystal layer includes a nematic liquid crystal.

8. The liquid crystal optical element according to claim 1, wherein the liquid crystal layer includes a cholesteric liquid crystal.

9. The liquid crystal optical element according to claim 1, further comprising an ultraviolet cut layer overlapping the second alignment film.

10. The liquid crystal optical element according to claim 1, wherein the substrate is a flexible substrate.
